(19) United States
(12) Patent Application Publication
(10) Pub. No.: US 2007/0218902 A1
(43) Pub. Date: Sep. 20, 2007

(54) System and method for adaptive seamless mobility of multimedia communication sessions

(76) Inventors: Darek Smyk, Piscataway, NJ (US); Jacek Korycki, Monmouth Junction, NJ (US); David Shrader, New York, NY (US); James Alfieri, Palmer Township, PA (US)

Correspondence Address: TELCORDIA TECHNOLOGIES, INC., ONE TELCORDIA DRIVE 5G116, PISCATAWAY, NJ, 08854-4157, US

(21) Appl. No.: 11/704,135

(22) Filed: Feb. 8, 2007

Related U.S. Application Data
(60) Provisional application No. 60/771,922, filed on Feb. 9, 2006.

(51) Int. Cl. H04Q 7/20

(52) U.S. Cl. 455/436

(57) ABSTRACT

A network-based Adaptive Seamless Mobility Controller provides a view not only of the capabilities of the specific device in use by the user but also the capabilities of the access network serving each user involved in the session. When the user equipment identifies the opportunity to enhance the communication through adaption of the session to include, for example, a video connection in addition to a voice connection, by utilizing a different access network and corresponding device, the network-based Adaptive Seamless Mobility Controller determines the end-to-end capabilities required for the session and coordinates the adaptation of the session characteristics in addition to providing seamless handover across domains.

### CROSS REFERENCE TO RELATED APPLICATION

This application claims the benefit of U.S. Provisional Patent Application No. 60/771,922 filed Feb. 9, 2006, the disclosure of which is hereby incorporated herein by reference.

### FIELD OF THE INVENTION

The present invention relates generally to the field of mobility management and the transfer of a multimedia communication session from one type of network to another without loss of the session.

### BACKGROUND OF THE INVENTION

This patent application pertains to the emerging wireless dual-mode phones which enable users to roam between WiFi and cellular (CDMA/GSM) access networks. When the dual-mode phone is in the range of a WiFi network, the phone operates in WiFi mode and uses WiFi for network access. Whenever the dual-mode phone roams away from the WiFi service area, the phone will start communicating through cellular network, i.e., the dual-mode phone switches from WiFi mode to cellular mode. When the dual-mode phone user returns to their home/building's WiFi network after being on the cellular network, the phone automatically starts using the WiFi network, i.e., dual-mode phone switches from cellular mode to WiFi mode.

A single Directory Number (DN) is used for the dual-mode phone whether the dual-mode phone user is operating in WiFi mode or in cellular (CDMA/GSM) mode. Phone calls to/from dual-mode phone will automatically be routed through WiFi or cellular network, depending on the current phone's mode. When the dual-mode phone switches modes while the call is in progress, the mode (access network) will be switched transparently to the user without interrupting the phone conversation.

Communication attributes of dual-mode phone's WiFi and cellular (CDMA/GSM) access networks most likely will differ, e.g. dual-mode phone could have access to different amount of bandwidth depending on which access network it uses. The objective of this patent application is to describe adaptive seamless mobility mechanism which will enable dual-mode phone's users to fully utilize available access network by adjusting communications session/call attributes to fit the capabilities of the access network. For example, let's assume that a video capable phone establishes a call with a video capable dual-mode phone, while the dual-mode phone is in cellular mode. Assuming that the cellular network does not provide sufficient access bandwidth to adequately support real-time video communications, the dual-mode phone will establish audio only call. However, according to this invention when dual-mode phone switches mode to broadband WiFi mode, after obtaining user(s) permission the dual-mode phone will automatically add one or two way video communication without interrupting the audio call. Conversely, when the dual-mode phone switches from wifi mode to cellular mode, the video portion of the call will be removed while the audio call will remain intact.

Adaptive seamless mobility benefits both users and service providers. Users gain access to improved modes of communication whenever the accessible wireless network is capable of supporting advanced communication. On the other hand, the service providers are enabled to offer revenue producing advanced communication services which are integrated with cellular network, while not taxing the cellular network resources for transporting higher bandwidth media streams. Please note, that the above mechanism could be generalized to other access networks, e.g. EDGE, and to applications other than two-way video communication, e.g., live video streaming where the video quality/size adapts to available access network.

The prior art is limited to technologies that solve portions of the problem, but not provide the full-range solution described in this disclosure. For example, mobility between a traditional wireless (CDMA or GSM) network and IP network (typically WiFi) for voice calls is subject to intense industry activity at this time. Four efforts are most prominent:
Voice Call Continuity (VCC) in 3GPP.
Voice Call Interoperability (VCI) in 3GPP2.
PacketCable 2.0 Voice Call Interoperability (VCI) in CableLabs
Unlicensed Mobile Access (UMA) in 3GPP.

Examples of some of the problems with the dijoint prior art approach are as follows. A session in progress is not enhanced if a user changes to a network or device with greater capabilities. In general, the user would need to terminate the existing session and initiate a new session using the new network or device. For example, a person initiates a video call to a user with a cell phone that does not support video. The user realizes (through conversation) that person wants to participate in a video call. The user asks the person to hang-up and call back to a device (such as a video soft phone) that supports video. It is therefore an objective of the present invention to overcome the disadvantages of this prior art approach that include:
The conversation between the person and user is disrupted.
The inconvenience of setting up a new call may reduce the attractiveness of enhanced communications (such as video calls).
Since the communication involves two calls, the person or user may incur additional charges compared to a single call.
Network conditions may change between the first and second call such that the second call can not be completed. In general, under conditions of network congestion, in-progress calls are favored over new call attempts.
   Similarly, there are also disadvantages in the prior art if the user changes to a network or device with lesser capabilities. Without this solution, the enhanced aspect of the session will often fail without notice to the person or user. Disadvantages of this approach include:
The far-end user (who does not change) may perceive the change as a failure and terminate the session, even if the “unenhanced” aspect is still working.
Inefficient use of network resources, if they are not properly cleared when the “enhanced” aspect of the session fails.
One of both of the users may be billed incorrectly (e.g., overbilled) if the billing data generated by the network for the session does not reflect that the “enhanced” portion of the session has failed.
   It is therefor the objective of this application to overcome the limitations of this prior art in addressing only portions of the problems but not the problem as whole.

### BRIEF SUMMARY OF THE INVENTION

The present invention sets forth a system and method for adaptive seamless mobility of multimedia communications sessions in heterogeneous networks through the introduction of an Adaptive Seamless Mobility Controller in the backbone network that connects the one or more heterogeneous networks. This Mobility Controller manages the signaling and call states for calls that transition between one or more such heterogeneous networks.

### BRIEF DESCRIPTION OF THE DRAWINGS

FIG. 1 is a depiction of a high level architecture for adaptive seamless mobility in accordance with the present invention; and,

FIG. 2 is a depiction of a high level call flow depicting handover of the communication session with adaptation of session attributes.

### DETAILED DESCRIPTION

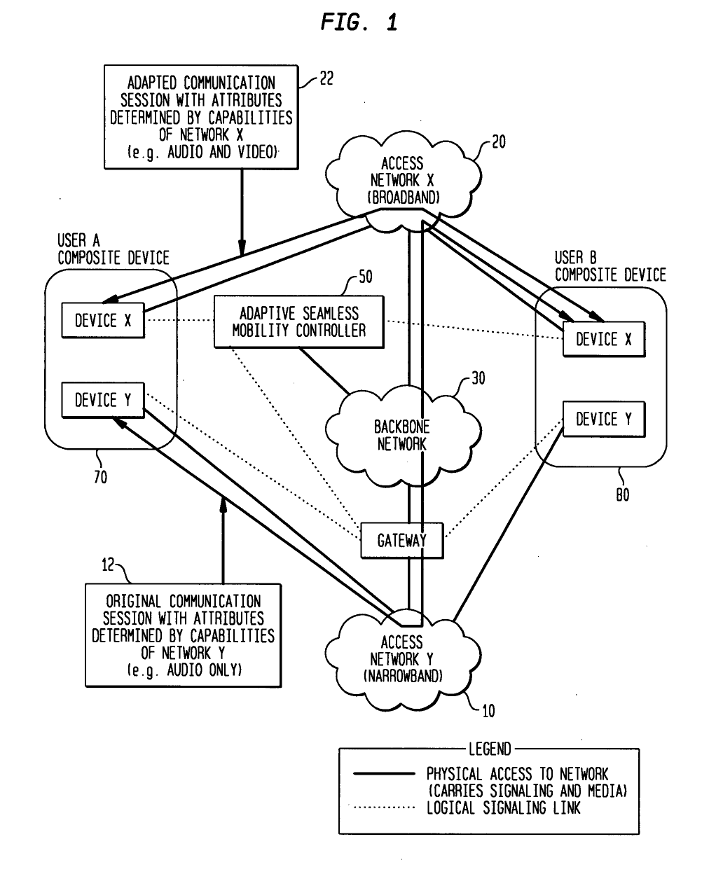

Our invention can be understood when applied in the context of the abstract model of the architecture for adaptive seamless mobility as shown on FIG. 1. Two access networks are shown. Network Y 10 is narrowband and allows limited communication session attributes. For example, network Y 10 may represent a cellular GSM network that allows audio sessions (basic voice calls) between the users. Network X 20 is broadband and allows expanded communication session attributes. For example, network X 20 may represent a WiFi-based broadband IP network that allows video as well as audio sessions between the users. The access networks 10 and 20 are connected to the backbone IP network 30 . If an access network is not IP-based (e.g. GSM network), then a Gateway element 40 is required between the access network 20 and the backbone network 30 to bridge the signaling and media for communication sessions that span the two access networks.

To illustrate one embodiment of our invention, we will assume that network X 20 is IP based and network Y 10 is not IP based. Hence there is only one Gateway element 40 shown on FIG. 1. We introduce an Adaptive Seamless Mobility Controller 50 is placed in the backbone network 40 and provides signaling and controll between the user devices 50 and 60 and gateway(s) in order to orchestrate the handovers of communication sessions between the networks.

FIG. 1 shows devices of two users who subscribe to adaptive seamless mobility service, user A and user B. Each user 50 and 60 is equipped with a composite devices 70 and 80 consisting of two elements: devices X 72 and 82 and devices Y 71 and 81, respectfully. Devices Y 72 and 82 work with network Y, can connect to it and exchange signaling and media over it. Devices Y 71 and 81 are able to process the content of the communication session traversing network Y 10 for the user according to the limited capabilities of network Y 10 For example, devices Y 71 and 81 can capture, send, receive and present the audio to and from the user. Similarly, devices X 72 and 82 work with network X 20, can connect to it and exchange signaling and media over it. Devices X 72 and 82 are able to process the content of the communication session traversing network X 20 for the user according to the expanded capabilities of network X 20. For example, devices X 71 and 81 can capture, send, receive and present the video and audio to and from the user.

Note that the composite device may take two forms: actual physical device with devices X and Y embedded inside of it or just a logical grouping of the two physical devices. In the former case, devices X and Y are invisible to the user and are implemented as components of a single composite device (e.g. dual-mode phone). In the latter case, the user deals with two separate physical devices X and Y that work in concert providing adaptive seamless mobility service to the user. For example, device Y may be a regular cellular phone and device X may be a video soft phone installed on a user's PC.

There are four possible types of communication sessions between user A and B, depending on whether each user has access to network X or Y: both users on network Y, user A on network X and user B on network Y, user A on network Y and user B on network X; and both users on network X.

The attributes of an end-to-end communication session between the two users are determined by the intersection of capabilities offered by the networks that are accessed by the users. For example, in case of network Y 10 supporting audio and network X 20 supporting video and audio, the intersection of capabilities is equivalent to common lowest denominator of the two network capabilities. If both users are on network X 20, video and audio is possible. If any of the users is on network Y 10, only audio is possible end-to-end despite the fact that the other user may be on the fast network X. This argument applies to other forms of communication than audio or video that are dependent on the capabilities of the two networks (e.g. shared viewing of a video stream).

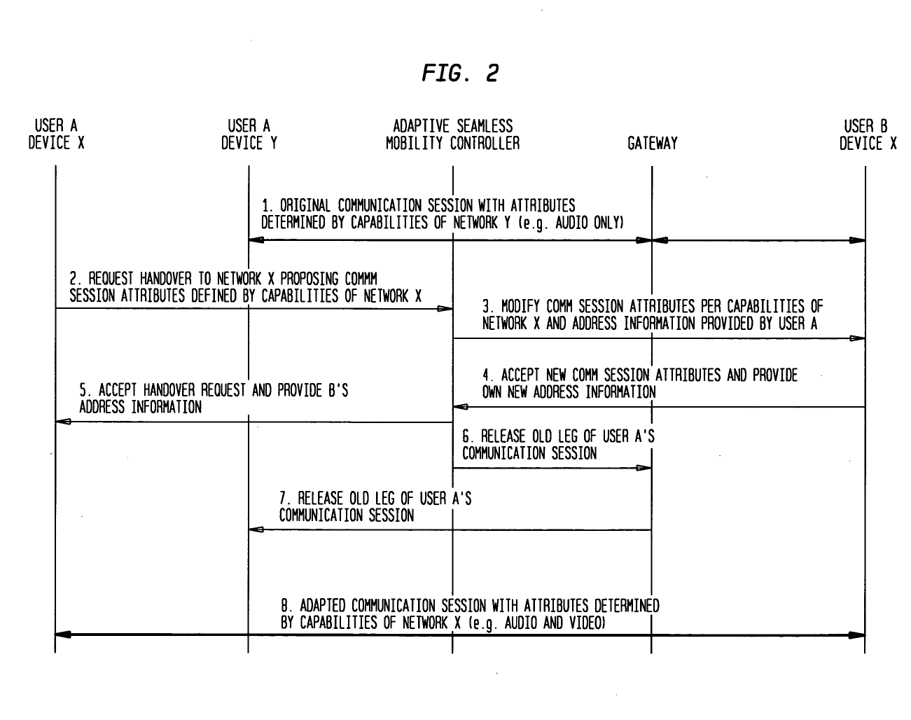

FIG. 1 illustrates a transition between two representative cases of communication sessions between user A and B. In the original state, there is a communication session 12 in progress between user A on network Y 10 and user B on network X 20. This communication session 12 is shown on FIG. 1 as a solid line. As discussed above, the communication session attributes are determined by capabilities of network Y (e.g., audio only). User A is represented on network Y by his/her device Y, similarly user B is represented on network X by his/her device X. At some point during the communication session, user A enters a service area of network X 10 (e.g. enters a WiFi hot-spot). This triggers a transformation implemented via signaling orchestrated by Adaptive Seamless Mobility Controller 50 located in backbone network 30. High level representation of this signaling is shown on FIG. 2. FIG. 1 shows the end result of this transformation: the adapted communication session between the two users on the same network X 20. User A is represented in the adapted session 22 by his/her device X 72 and device Y 71 is no longer supporting user A's communication. The adapted session 22 is graphically represented on FIG. 1 as a thick solid line. The difference of thickness between the original line and the adapted line represents expanded communication session attributes.

The gist of the adaptive transformation, and the key to our invention, is the use of the Adaptive Seamless Mobility Controller 50 to enable the communication session expands automatically to include the new attributes (such as the video component) that were not possible before the user gained access to network X 20. This is in contrast with the prior art mobility techniques which are oriented on preserving the same communication session attributes without taking advantage of different (improved) capabilities of the new end-to-end network path.

In one embodiment of our invention the session attributes can be adjusted in a fully automated manner but in another embodiment the session attributes could adjusted in a manner that requires a user's permission to do so. Permission granting process can be optimized to make the service more ergonomic, e.g. require only a single click on the user's device. Alternatively the permission granting process may be governed by a policy set by the user in advance and invoked automatically without user's intervention during handover.

When user A leaves the service area of network X 20, the reverse transformation will take place, again orchestrated by the Adaptive Seamless Mobility Controller. The end result of the transformation will be contracting of the communication session attributes to those supported by the capabilities of network Y (e.g. dropping the video component and maintaining the audio component).

These two cases (user B on network X and user A moves from network Y to X and back) are sufficient to represent our invention, i.e. the adaptive aspect of the seamless mobility. Other cases fall into a traditional seamless mobility where the communication session attributes stay the same and do not undergo adaptation. For example, this refers to the case when user A and user B are both on network Y and user A moves to network X. The specific signaling used by our Adaptive Seamless Mobility Controller 50 in accordance with our invention will depend on the attributes and characteristics of networks X 20 and Y 10.

FIG. 2 illustrates a functional representation of the flow. FIG. 2 shows the original communication session (step 1, solid line) and the adapted communication session (step 8, thick solid line). In between, there are abstract signaling messages (steps 2-7), exchanged between user devices, the Adaptive Seamless Mobility Controller 50 and the gateway 40. Note that the actual mapping to the concrete technology employed in network X and Y may require adding more messages (e.g. acknowledgements). However these additional concrete messages will not affect the essence of the flow with respect to our invention. Note that since we assumed that network X is IP based and network Y is not IP based, the Adaptive Seamless Mobility Controller 50 signals to devices X 72 and 82 directly and to devices Y 71 and 81 indirectly via the Gateway 40.

Note that on FIG. 2 the adaptive handover is initiated by the device X 72 of user A. In the actual implementation this step may be preceded by an exchange of messages between the user's device and the Adaptive Seamless Mobility Controller 50 via which a controller may help the device reach a decision to initiate the handover, considering issues such as signal strength, quality of service and threshold levels preventing oscillation of handover and handback cycles. At any rate, it is up to the user's device to eventually issue a handover request to the Adaptive Seamless Mobility Controller 50 in which it includes its desire to adapt the communication session attributes and the address information supporting the adapted session. Note that the device may also request a traditional seamless mobility handover without adaptation if such adaptation is not desired. The adaptation may not be desired if the device cannot support the adapted communication session attributes (e.g. video) for technical reasons or if the user's policy states that adaptation should not take place.

This solution provides a network-based Adaptive Seamless Mobility Controller 50 that provides a view not only of the capabilities of the specific device in use by the user but also the capabilities of the access network serving each user involved in the session. When the user equipment identifies the opportunity to enhance the communication through adaption of the session to include, for example, a video connection in addition to a voice connection, by utilizing a different access network and corresponding device, the network-based Adaptive Seamless Mobility Controller determines the end-to-end capabilities required for the session and coordinates the adaptation of the session characteristics in addition to providing seamless handover across domains.

In view of the variety of embodiments to which the principles of the present invention can be applied, it should be understood t hat the illustrated embodiments are exemplary only, and should be taken as limiting the scope of the present invention. For example the steps illustrated in FIG. 2 may be taken in sequences other than those described. The claims should be read as limited to the described order or elements stated to that effect. Therefore, all the embodiments that come within the scope and spirit of the following claims and equivalents thereto are claimed as the invention.

What is claimed is:

1. A method for enabling the transfer of a multimedia communications session from a first network having one set of communications attributes to a second network having a different set of communications attributes without the loss of the session comprising the steps of:
receiving from a user of said first network a request to handover said communications session to said second network;
checking the communications attributes of said second network; and
handing over to said second network said communications session wherein said communications attributes of said communications session are modified to be consistent with the capabilities of said second network.

2. The method of claim 1 further comprising the steps of:
asking a user in said second network for permission to modify said communications attributes prior to modifying said communications sessions attributes;
handing over to said second network said communications session without modifying said session's attributes if said request for permission is denied.

3. A method for seamlessly moving a communications session established between two users of dual mode mobile phones when said session is between a first user operating in a first mode of said mobile phone and said second user is operating in said second mode of said mobile phone, said method comprising the steps of:
when said first user moves into an environment where a network is accessable by said second mode in said first users phone, sending a request to the network to move said communications session to said second network using said second mode;
at a mobility controller in said network, modifying the communications attributes of said communications session to be consistent with the capabilities of said second network; and
moving said communications sessions to said second network such that said second mode of said first users phone is enabled.

4. The method of claim 3 wherein said second users is asked permission to modify the communications attributes before said moving step and if said request is denied said communications session is moved without said communications attributes are modified.

5. The method of claim 3 wherein said first network is a cellular access network.

6. The method of claim 5 wherein said second network is a WIFi network.
